(19) United States
(12) Patent Application Publication
(10) Pub. No.: US 2004/0208476 A1
(43) Pub. Date: Oct. 21, 2004

(54) Digital camera system

(76) Inventors: Neal Jacob Manowitz, Woodcliff Lake, NJ (US); John Tree, San Francisco, CA (US)

Correspondence Address: Richard H. Butler, Valley Oak Law, 5655 Silver Creek Valley Road, #106, San Jose, CA, 95138, US

(21) Appl. No.: 09/782,067

(22) Filed: Feb. 12, 2001

Related U.S. Application Data
(60) Provisional application No. 60/181,839, filed on Feb. 11, 2000.

(51) Int. Cl. H04N 5/781; H04N 7/00

(52) U.S. Cl. 386/46; 386/125; 386/94

(57) ABSTRACT

The digital camera system includes a digital camera, a predetermined remote location, a camera distributor and an advertiser. The digital camera is configured to exclusively and automatically connect to the predetermined remote location to upload image data to the predetermined remote location and to download advertising data from the predetermined remote location. The digital camera is also configured to display the advertising data and utilizes the predetermined remote location as the sole way to distribute the image data. The advertiser compensates the camera distributor and the owner of the predetermined remote location based on the advertising data which is viewed by the camera user. In turn, the camera distributor is able to reduce the cost of the digital camera to the camera user.

### RELATED APPLICATIONS

This application claims the benefit of U.S. Provisional Application No. 60/181,839, filed on Feb. 11, 2000.

### COPYRIGHT NOTICE/PERMISSION

A portion of the disclosure of this patent document may contain material which is subject to copyright protection. The copyright owner has no objection to the facsimile reproductions by anyone of the patent document or the patent disclosure as it appears in the patent in trademark office patent file or records, the otherwise reserves all copyrights whatsoever. The following notice applies to software and data as described below and in the drawings hereto: Copyright 2001, Sony electronics Inc., All Rights Reserved.

### FIELD OF THE INVENTION

This invention relates generally to the field of digital imaging. More particularly, this invention relates to data transmission between a digital camera and a remote location.

### BACKGROUND OF THE INVENTION

Digital cameras provide many technological advances over the standard analog cameras. Digital cameras allow users to instantly manipulate the resulting digital images, view these images, distribute these images, and the like. Unfortunately, digital cameras are expensive to purchase and are difficult to operate. Furthermore, uploading digital images obtained from the digital camera to any external device typically requires multiple steps which add complexity to the operation of these digital cameras.

### SUMMARY OF THE INVENTION

The digital camera system includes a digital camera, a predetermined remote location, a camera distributor and an advertiser. The digital camera is configured to exclusively and automatically connect to the predetermined remote location to upload image data to the predetermined remote location and to download advertising data from the predetermined remote location. The digital camera is also configured to display the advertising data and utilizes the predetermined remote location as the sole way to distribute the image data. The advertiser compensates the camera distributor and the owner of the predetermined remote location based on the advertising data which is viewed by the camera user. In turn, the camera distributor is able to reduce the cost of the digital camera to the camera user.

### BRIEF DESCRIPTION OF THE DRAWING

FIG. 1A illustrates a basic system of the present invention.

FIG. 1B illustrates a network overview of the present invention.

FIG. 1C illustrates a basic processor of the present invention.

FIG. 2 illustrates an overview of an embodiment.

FIG. 3 illustrates a block diagram of one embodiment.

FIG. 4 illustrates a flow diagram of one embodiment.

FIG. 5 illustrates a flow diagram of another embodiment.

### DETAILED DESCRIPTION OF THE INVENTION

In the following detailed description of the embodiments of the invention, reference is made to the accompanying drawings in which like references indicate similar elements, in which, is shown by way of illustration of specific embodiments in which the invention may be practiced. These embodiments are described in sufficient detail to enable those skilled in the art to practice the invention and is to be understood that other embodiments may be utilized and that logical, mechanical, electrical and other changes may be made without departing from the scope of the present invention. The following detailed description is, therefore, not to be taken in a limiting sense, and the scope of the present invention is defined only by the appended claims.

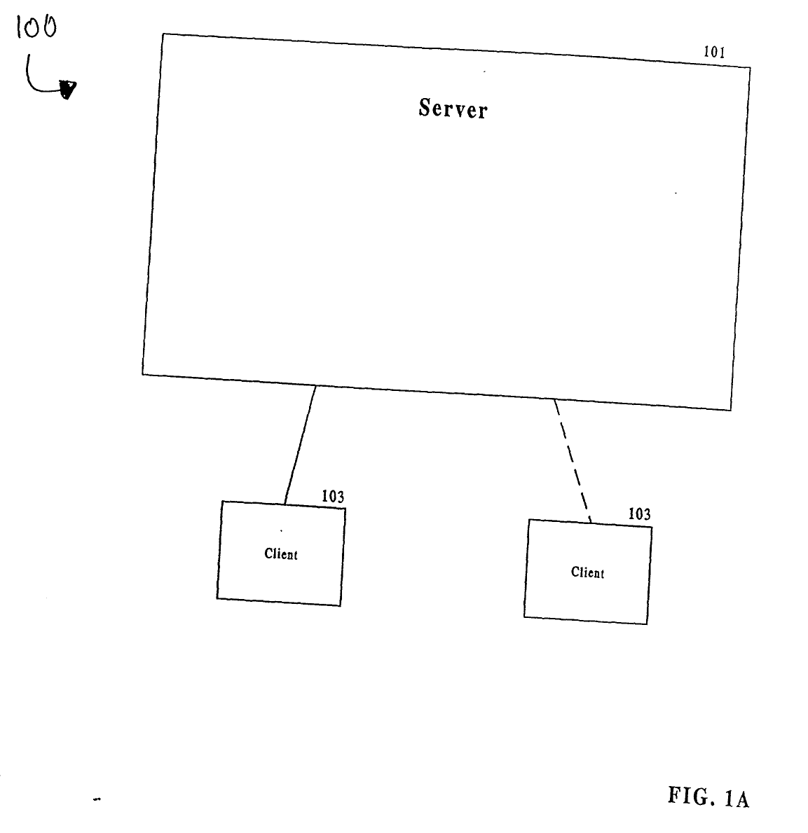

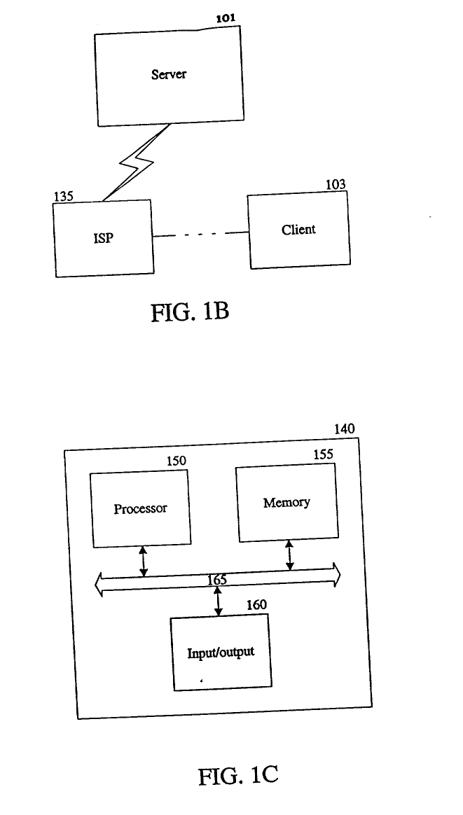

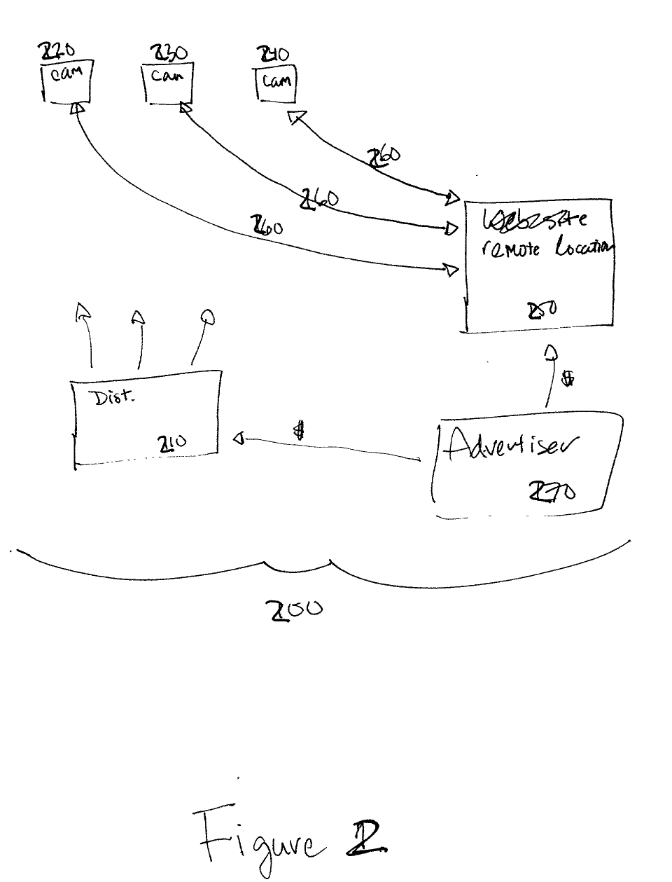

Beginning with an overview of the operation of the invention, FIG. 1A illustrates system 100 which can control the transmission of digital images according to one embodiment of the present invention. System 100 includes server 101 in one or more clients 103. Clients 103 represent any device that may enable user's online access to information such as a digital camera. In this embodiment, client 103 is a digital camera device which allows the user to transmit digital imaging data to remote devices. In this embodiment, client 103 may provide a user interface to communicate information to the user. It should be noted that although FIG. 1A illustrates only two modules performing the above functionality, more or less modules may be used to perform this functionality.

In one embodiment, as shown in FIG. 1B, server 101 hosts a web site and is part of or coupled to an Internet Service Provider 135 to provide services over the Internet.

The client computer 103 executes a conventional Internet browsing application to exchange data with the server 101. It is readily apparent that the present invention is not limited to Internet access and Internet Web based sites; directly coupled and private networks are also contemplated.

One embodiment of computer system 140 suitable for use as a server 101 is illustrated in FIG. 1C. In some embodiments, in which client 103 is a computer, computer system 140 may be suitable for use as a client 103. Computer system 140, includes processor 150, memory 155 and input/output capability 160 coupled to system bus 165. Memory 155 is configured to store instructions which, when executed by processor 150, perform the steps described herein. Input/output 160 provides for the delivery and display at information to others. Input/output 160 also encompasses various types of computer readable media, including any type of storage device that is accessible by the processor 150. One of the skilled the art will immediately recognize that the term computer readable media further encompasses a carrier ways that enclosed a data signal. It will also be appreciated that the server 101 is controlled by operating system software executing and memory 155. Input/output and related media 160 store the computer executable instructions for the operating system and methods of the present invention.

The description of FIGS. 1B and 1C are intended to provide an overview of computer hardware and other operating components suitable for implementing the invention, but is not intended to limit the application environments. You'll be appreciated that computer system 140 is one example of many possible computer systems to have different architectures. A typical computer system will usually include at least a processor, memory, any bus coupling the memory to the processor. One of skill in the art will immediately appreciate that the invention can be practiced with other computer system configurations including microprocessor systems, minicomputers, mainframe computers, and the like. The invention can also be practiced in distributed computing environments where tasks are performed by remote processing devices are linked through communications network.

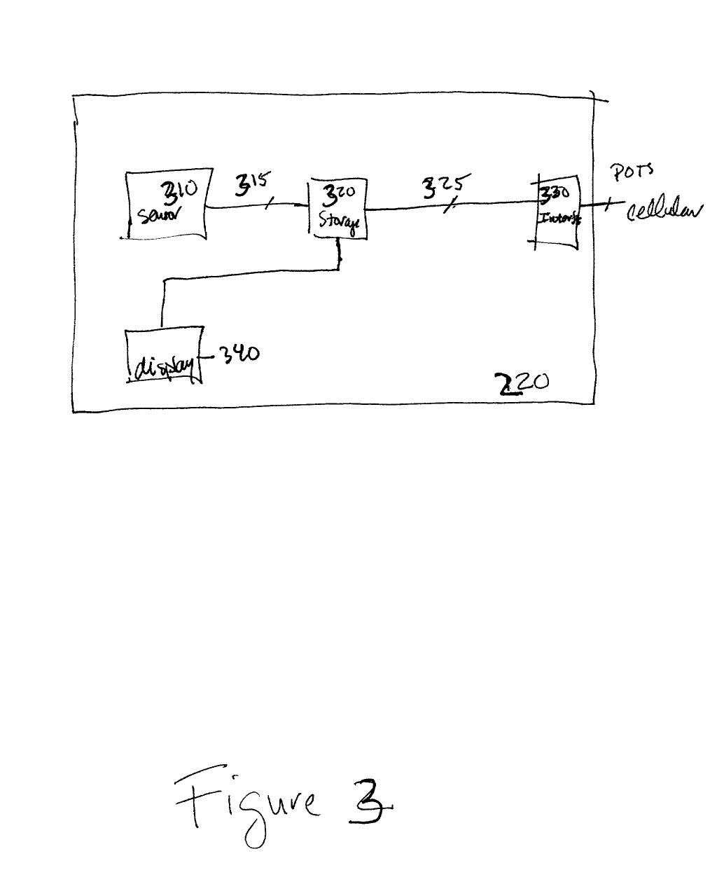

FIG. 2 illustrates an overall system 200 of a subsidized camera distribution system. The overall system 200 illustrates one embodiment of the present invention. The overall system 200 includes but is not limited to a distributor 210, a camera 220, a camera 230, a camera 240, a remote location 250, data line 260, and advertiser 270. The distributor 210 may include a camera manufacturer, a camera wholesaler, a camera distributor, a camera retailer or any combination thereof. The cameras 220, 230 and 240 are shown within the overall system 200 for illustrative purposes only. There can be additional or fewer cameras depending on the specific embodiment. In this embodiment, the distributor 210 provides the cameras 220, 230 and 240 to users in exchange for compensation. This compensation may include but not limited to a combination of money directly from the users of cameras 220, 230 and 240 and from indirect advertising revenues generated from advertisers. In another embodiment, the distributor 210 may forgo receiving any money from the users of the cameras 220, 230 and 240 in exchange for advertising revenues received through another party such as the advertiser 270. In yet another embodiment, the advertiser 270 and the distributor 210 may be the same entity.

In this embodiment, the cameras 220, 230 and 240 are configured to only be able to communicate with the remote location 250. In this embodiment, the cameras 220, 230 and 240 are configured to be unable to communicate with any other external devices besides the remote location 250. The cameras 220, 230 and 240 are able to communicate with the remote location 250 through the data line 260. The data line 260 may include a network, the internet, a plan old telephone system (POTS), a cellular connection, or the like. In this embodiment, the remote location 250 is a server connected to the internet which is illustrated through data line 260.

In one embodiment, the advertiser 270 pays the distributor 210 based on the number of sales distributor makes of the cameras 220, 230 and 240 to other users. The advertiser 270 also compensates the remote location 250 for storing files from the cameras 220, 230 and 240 and for advertising onto the cameras 220, 230 and 240. In another embodiment, the advertiser 270 compensates the distributor 210 based on the numbers of cameras the distributor distributes and also compensates the distributor 210 for servicing the remote location 250. In turn, the distributor 210 would be responsible for the maintenance and upkeep of the remote location 250.

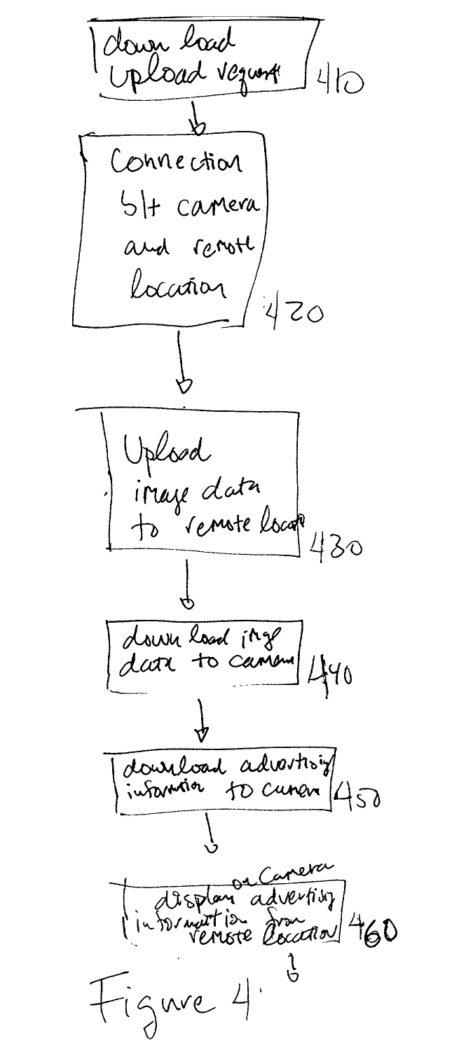

FIG. 3 illustrates one embodiment of the camera 220. The camera 220 includes but is not limited to a sensor 310, a storage device 320, a display 340, an interface device 330, dataline 315, and data line 325. The sensor 310 converts analog data into electronic image data. The sensor 310 can utilize technologies such as charge couple devices, CMOS sensors, and the like. In this embodiment, the storage device 320 stores the image data from the sensor 310. The image data is transmitted from the sensor 310 to the storage device 320 via the dataline 315. The storage device 320 may include but is not limited to flash memory, magnetic media, or the like. The display 430 is connected to the storage device 320 and is configured to display the image data and/or advertising data.

The interface device 330 is configured to receive the stored image data from the storage device 320 via the data line 325. The interface device 330 allows the stored image data to be outputted from the camera 220. This outputted image data can be transmitted out of the camera 220 via plan old telephone service (POTS), cellular service, or the like. The interface device 330 is configured to communicate with a predetermined external device. In one embodiment, the external device is the remote location 250 (FIG. 1). In another embodiment, the sensor 310 directly transmits the image data from the sensor 310 to interface device 330. In this embodiment, the storage device 320 is not needed.

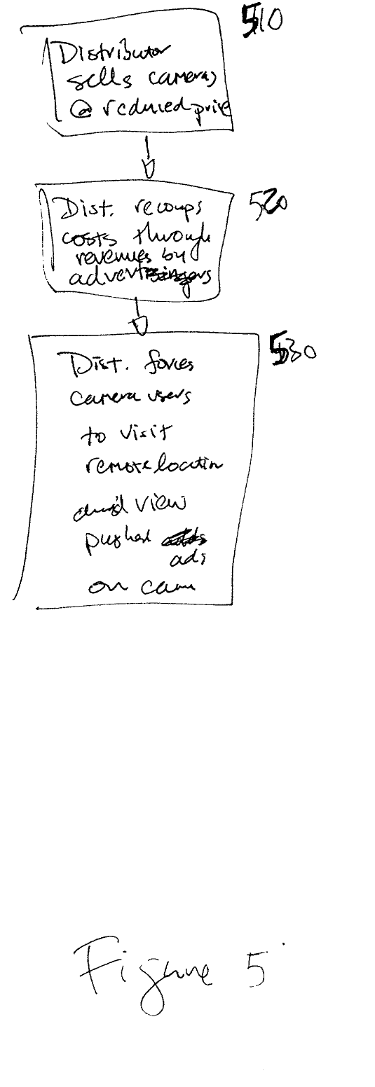

FIG. 4 illustrates a flow diagram of one embodiment of this invention. Block 410 illustrates the download and upload request. The upload request may occur when there is image data that needs to be transmitted from the camera 220 to an external device. The download request can occur at a predetermined time or upon the request of the external device. In block 420, a connection occurs between a camera and a remote location. In one embodiment, the camera 220 via the interface device 330 connects to the remote location 250. Block 430 shows that the image data is uploaded from the camera 220 to the remote location 250. In the block 440, image data is downloaded from the remote location 250 to the camera 220. In one embodiment, the remote location 250 serves as a remote storage location for the camera 220. For example, the camera 220 is able to upload image data and have it stored at the remote location as illustrated in block 430. In another example, the stored image data on the remote location 250 can be downloaded to the camera 220 for viewing on the camera 220 as illustrated in the block 440. In the block 450, advertising and/or other information is downloaded from the remote location 250 to the camera 220. In one embodiment, the advertising and/or other information is not in content created by the camera 220, rather it is content that is transmitted to the camera 220. In block 460, this advertising and/or other information from the remote location 250 is displayed on the camera 220. In one embodiment, the advertising which resides on the remote location 250 can be transmitted to the camera 220 at regular intervals for display on the camera 220. In another embodiment, the advertising which is stored on the remote location 250 is transmitted to the camera 220 when the camera 220 connects to the remote location in order to upload image data from the camera 220 to the remote location 250.

FIG. 5 illustrates interactions between the distributor 210 and other parties. In this embodiment, in block 510 the distributor sales cameras to others at a reduced price. In another embodiment, the distributor gives these cameras away to other users. In block 520, the distributor recoups costs by either selling the cameras at a reduced or giving away the cameras through revenue generated by the advertisement viewed the camera user. In block 530, the distributor controls the camera's access to external devices. In this embodiment, the distributor only allows the cameras to connect with the remote location 250 and advertisement is pushed onto the camera.

Although specific embodiments have been illustrated and described herein, will be appreciated by those of ordinary skill in the art that any arrangement which is calculated to achieve the same purpose may be substituted for specific embodiments shown. This application is intended to cover any of the adaptations or variations of the present invention.

The terminology used in this application with respect to network architecture is meant to include all client/server environments. Therefore it is manifestly intended that this invention be limited only by the following claims and equivalents thereof.

What is claimed is:

1. A system for transmitting image data comprising:
a remote storage device for receiving image data and
a digital camera configured to send the image data exclusively to the remote storage device.

2. The system according to claim 1 wherein the digital camera further comprises a
sensor for forming the image data.

3. The system according to claim 1 wherein the digital camera further comprises
a local storage device for storing the image data and advertising data from the remote storage device.

4. The system according to claim 3 wherein the digital camera further comprises a display device for view ing the image data and the advertising data.

5. A method of communicating between a digital camera and a predetermined remote location comprising:
uploading image data from a digital camera to a predetermined remote location;
downloading advertising data from the predetermined remote location to the
digital camera; and
displaying the advertising data on the digital camera.

6. The method according to claim 5 further comprising an advertiser compensating a distributor based on the advertising data downloaded by the digital camera.

7. The method according to claim 5 further comprising a distributor selling the digital camera to a user at a discount based on the advertising data downloaded by the digital camera.

8. The method according to claim 5 wherein uploading the image data occurs only at the predetermined remote location.

9. A digital camera comprising:
a buffer for receiving image data and advertising data;
an interface connected to the buffer configured to upload the image data from the digital camera to a predetermined remote location and to download the advertising data from the predetermined remote location to the digital camera; and
a display connected to the buffer for viewing the advertising data.

10. The digital camera according to claim 9 further comprising a sensor connected to the buffer for forming the image data.

11. The digital camera according to claim 9 wherein the interface is configured to automatically connect with the predetermined remote location for uploading the image data and downloading the advertisement data.
